(19) United States
(12) Patent Application Publication
(10) Pub. No.: US 2008/0184028 A1
(43) Pub. Date: Jul. 31, 2008

(54) Methods, Apparatus and Products for Establishing a Trusted Information Handling System

(75) Inventors: Douglas M Anson, Dripping Springs, TX (US); Frank Howard Molsberry, Georgetown, TX (US)

Correspondence Address: ANDREA E. TRAN;PRAMUDJI WENDT & TRAN, LLP, 1800 BERING DRIVE, SUITE 540, HOUSTON, TX, 77057, US

(73) Assignee: Dell Products L.P., Round Rock, TX (US)

(21) Appl. No.: 11/668,466

(22) Filed: Jan. 29, 2007

(51) Int. Cl. H04L 9/32

(52) U.S. Cl. 713/156

(57) ABSTRACT

A method for modifying a trusted information handling system (IHS) is disclosed that includes providing a trusted component (TC) on the IHS and providing at least one third party TC on the IHS. A trusted IHS is disclosed that includes a processor in data communication with memory, a user TC on the trusted IHS for receiving user data establishing a user foundation of trust (FOT) and at least one third party TC on the trusted IHS for establishing a third party FOT.

### BACKGROUND

1. Technical Field

The present disclosure relates generally to information handling systems (IHSs) and more particularly to trusted IHSs.

2. Background Information

As the value and use of information continues to increase, individuals and businesses seek additional ways to process and store information. One option available to users is an information handling system (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

The variations in IHSs allow for information handling systems to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

In today's information based society, privacy issues have become an increasing concern. Personal computers and the Internet enable people to access more information at rates never before possible. Many of the tasks for which people use the Internet however, are considered highly private or confidential matters based on information that should remain confidential. Coupled with the advantages that accrue from the Internet is an increased susceptibility to malicious eavesdropping and/or cyber-attack on processors and private information. Thus, as the tools with which people conduct their daily affairs advance in complexity, so too should the means by which private or confidential matters and information are safeguarded. One example of advancing safeguards is by industry leaders who have organized a Trusted Computing Group (TCG) to address these information safeguarding concerns.

### SUMMARY

The following presents a general summary of some of the many possible embodiments of this disclosure in order to provide a basic understanding of this disclosure. This summary is not an extensive overview of all embodiments of this disclosure. This summary is not intended to identify key or critical elements of the disclosure or to delineate or otherwise limit the scope of the claims. The following summary merely presents some concepts of the disclosure in a general form as a prelude to the more detailed description that follows.

In a particular illustrative embodiment a method for modifying an information handling system (IHS) is disclosed. The method includes providing a user trusted component (TC) on the IHS and providing a third party TC on the IHS.

In another particular illustrative embodiment an IHS is disclosed. The a memory on the IHS, a processor on the IHS in data communication with memory, a user trusted TC for receiving user data establishing a user owned Foundation of Trust (FOT), and a third party TC for establishing a third party owned FOT.

In another particular illustrative embodiment a data structure in memory is disclosed. The data structure includes a first field, such as an IHS identification field for storing data indicative of an IHS identifier and a second filed, such as a third party FOT field for storing data indicative of a third party FOT.

In another particular illustrative embodiment a computer readable medium containing a computer program is disclosed. The computer program includes instructions to establish a user FOT on an IHS using a user TC and instructions to establish a third party FOT on the IHS.

In another particular illustrative embodiment a method for operating on data an IHS having a user owned FOT and a third party owned FOT is disclosed. The method includes sending data to the HIS wherein the data is controlled by the third party FOT and operating on the data using the third party owned FOT.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 is a high level diagram of an illustrative embodiment of an information handling system having multiple roots of trust.

FIG. 2 is a high level drawing showing an illustrative embodiment of a trusted platform module (TPM).

FIG. 3 is a high level diagram showing an illustrative embodiment of an IHS containing multiple TPMs, each TPM having separate and exclusive ownership.

FIG. 4 is a high level diagram of an illustrative embodiment of a plurality of IHSs having multiple roots of trusted managed by a third party trusted relationship manager.

FIG. 5 is an illustration of an illustrative embodiment of a data structure for storing data for managing a trusted relationship foundation (TRF) such as a root of trust (ROT).

FIG. 6 is a flow chart for an illustrative embodiment of a method wherein an original equipment manufacturer (OEM) initializes TPM in an IHS before shipping the IHS.

FIG. 7 is a flow chart for an illustrative embodiment of a method wherein an OEM installs multiple ROTs remotely setup by a third party.

FIG. 8 is a flow chart for an illustrative embodiment of a method for creating a ROT from a FOT.

### DETAILED DESCRIPTION

Various other non-limiting embodiments of an illustrative embodiment of a method for modifying an IHS may include any combination of one or more of the following: (1) establishing a third party foundation of trust (FOT) on the IHS using the third party TC; the TC is a trusted platform module (TPM) and the FOT is a root of trust (ROT) wherein the TC is selected from the group consisting of a subscriber identity module (SIM), software module secure flash and smart card; (2) establishing third party ownership of the third party TC, wherein establishing third party ownership of the TC further comprises creating data selected from the group consisting of a personal identification number (PIN) a private key, a public key, an endorsement key and presence indicator, (3) establishing a derivative FOT from the third party FOT; (4) receiving data at the third party TC from outside the IHS a remote location managing the third party TC; and (5) receiving data at the IHS resetting the third party TC wherein the data is sent from a source selected from the group consisting of an IHS user, a third party vendor, and a third party trusted relationship manager. As used herein, TPM is both the name of a published specification detailing a microcontroller that can store secured information as well as the general name of implementations of that specification, and may comprise hardware, software, or both.

Various other non-limiting illustrative embodiments of an illustrative IHS may include any combination of one or more of the following, (1) a third party TC as a trusted platform module (TPM) and the FOT is a root of trust (ROT), wherein the TC is selected from the group consisting of a SIM, software module, secure flash, and smart card; (2) the third party has exclusive access to the third party TC; (3) the third party FOT is a ROT and the third party ROT receives data establishing third party ownership of the third party ROT: wherein the data establishing third party ownership further comprises data comprising at least one selected from the group consisting of a personal identification code, private key, public key, endorsement key and presence indicator.

Various other non-limiting illustrative embodiments of an illustrative data structure may include any combination the following: a fourth data field for storing data indicative of a derivative FOT. Various other non-limiting illustrative embodiments of an illustrative IHS may include any combination of one or more of the following: (1) instructions to establish a user FOT on an information handling system (IHS) using a user trusted component (TC); (2) instructions to establish a third party FOT on the IHS using a third party TC; and (3) instructions to establish third party ownership of the third party TC.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

TCG is an industry standards body, including computer manufacturers, device manufacturers, and software vendors, who have organized to promote the security of computing platforms and devices (see, https:///www.trustedcomputinggroup.org) which is hereby incorporated herein by reference in its entirety. One goal of TCG is to promote trust in a security hardware device called the trusted platform module (TPM). The TPM is described in specifications published by the TCG, such as the TPM Main Specification, Parts 1-3, Version 1.2, Oct. 2, 2003 which is incorporated herein by reference. The TPM is an isolated device which can be built into the motherboard of a computer system such as an IHS for establishing trust and trust metrics in a Trusted Computing Environment.

A Trusted Platform is a computing platform or IHS that has a trusted component (TC), a hardware or software component, in the form of built-in hardware or software, which the TC uses to create a FOT for software processes and data communication. The computing platforms listed in the Trusted Computing Platform Alliance (TCPA) specification are one such type of Trusted Platform. Although different types of Trusted Platforms could be built, an illustrative embodiment includes the (version 1.1) instantiation specified by the TCPA industry standard.

One example of a Trusted Platform is a normal open computer platform such as an IHS that has been modified to provide an FOT to establish and maintain additional or enhanced privacy. In one particular illustrative embodiment, the FOT does this by providing the following basic functionalities: A mechanism for the IHS to show that it is executing the expected software, a mechanism for the platform to prove that it is a IHS while maintaining anonymity (if required), and protection against theft and misuse of secrets held on the IHS.

A trusted IHS is defined, for use in this disclosure as an IHS in which there is a trusted and/or authenticated component that provides a FOT. The FOT, which may be an ROT, provides a higher degree of certainty that the IHS as a sender or requestor of data is who they say they are and as a receiver of data will not misuse the data received. A trusted IHS is based on a trusted device component FOT used to create a FOT or ROT. There may be other trusted components other than the TPM, such as a subscriber identity module (SIM) card, smart card or secure flash. The Trusted Computing Group (TCG) defines a ROT as a component that always behaves in an expected manner.

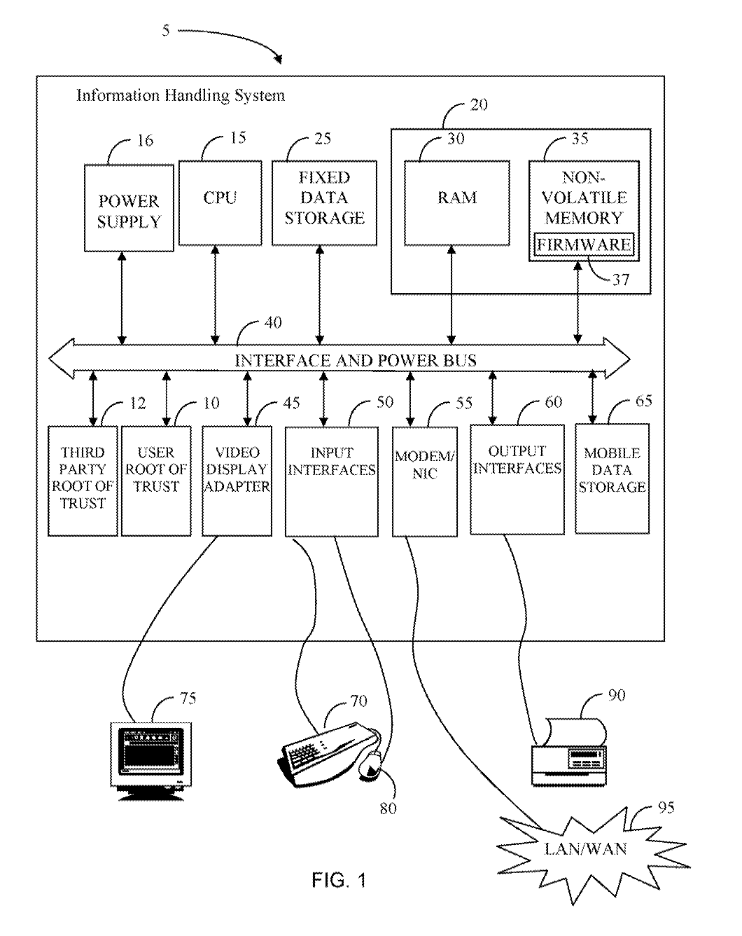

Referring to FIG. 1, in an example of a particular illustrative embodiment an IHS 5, according to one aspect, comprises a power supply 16, also called a power converter. While IHS 5 is provided as an illustrative embodiment, the present disclosure is also applicable to any digital device including but not limited to personal data assistant (PDAs), cell phones web notebooks and any other digital device capable of sending and/or receiving digital data. Power supply 16 is connected to other components of the information handling system through interface and power bus 40. Power supply 16 may be a switch mode power supply. Interface and power bus 40 is shown herein as a single bus for simplicity but may comprise separate electrical conduction paths for data communication and power. For example, power may be transmitted to various components through cables (not shown) connected between the power supply and various components. Likewise, multiple conductors may be used for data communication.

IHS 5 may include a first trusted component, such as a TPM as provided to create a user foundation of trust (FOT), such as a root of trust (ROT) 10 and second FOT trusted component used to create a third party FOT such as a ROT 12. Hardware or software TCs are used to create an POT such as an ROT.

In digital rights management (DRM) or content rights management (CRM), software TCs and ROTs have been used to prevent illegal piracy or the like. However, some software TCs and ROTs are controllable by the IHS or IHS user so the user software TC/ROT may be hacked by sophisticated IHS users. With access to keys for the user TC/ROT, the user can decrypt protected content without appropriate authorization.

In one particular illustrative embodiment, a set of ROTs has a set of functions to enable a description of the IHS characteristics that affect the trustworthiness of the IHS (see, e.g. https://www.trustedcomputinggroup.org/groups/glossary/). ROTs allow IHS identity to be established and hardened, a user identity to be established and hardened, detection of software tampering, and access control resources to be controlled and hardened. In an illustrative embodiment a ROT contains keys for signing, verification, encryption, and/or decryption.

In an illustrative embodiment a trusted relationship is based on a TC/FOT such as a hardware device or software or firmware module. A hardware TC/FOT is based on a hardware device that may include but is not limited to a trusted platform module (TPM). In another particular embodiment, a hardware TC/FOT is based on a smart card, a SIM card, secure flash memory, or a similar hardware device. The trusted hardware or software component upon which a ROT or other FOT which serves as a basis of a trusted relationship is built is referred to herein as a TC. The hardware FOT, such as the TPM is contained within an IHS and not easily removed from the IHS. In another particular embodiment the hardware basis of trust is not contained within the IHS but is in secure data communication with the IHS. Access to a TC that creates the FOT or ROT may be tied to personal identification number (PIN) or similar identifying data. In some cases, ownership may be tied to the TC and/or the FOT or ROT.

In a particular illustrative embodiment, a TPM is used as a TC to create a ROT. In a particular illustrative embodiment, the TPM is a hardware microcontroller that stores keys, passwords and digital certificates. A TPM is generally attached to an IHS, where the ROT information stored in the hardware TPM is hardened or made more secure from external software attacks and physical theft. For example, access to data and secrets in an IHS having a TPM can be denied if the IHS boot sequence is not as expected by the TPM. Critical applications and capabilities such as secure email, secure web access and local protection of data are thereby made much more secure by a ROT such as a TPM, or another TC such as a smart card, SIM card or similar hardware device or software program. In another particular embodiment, a TC is software based. In some embodiments, the hardware TC may be more secure than a software TC.

TPMs and associated or similar TCs for ROTs provide features that can include but are not limited to remote attestation, sealing, and binding. Remote attestation creates a summary of the software executing on an IHS that cannot easily be counterfeited or forged, which enables a third party to verify that the software on an IHS having a particular ROT has not been compromised. Sealing encrypts data in a manner that only allows the same IHS running the same software to encrypt the data to decrypt the data. Binding encrypts data using a TPM endorsement key or trusted key. Other features of TPM can be found in the TPM specification version 1.2, revision 94, published Mar. 29, 2006. The TPM specification is hereby incorporated by reference in its entirety.

In FIG. 1, CPU 15 may be a processor, microprocessor, minicomputer, or any other suitable device, for executing programmed instructions. CPU 15 may comprise one or any combination or number of such processors, microprocessors, minicomputers, and other devices. CPU 15 may be in data communication over interface and power bus 40 with fixed data storage 25 and memory 20.

Memory 20 comprises non-volatile memory 35 having a firmware program 37, such as an initialization start-up program, stored therein. Non-volatile memory includes, but is not limited to flash memory and electrically erasable programmable read-only memory (EEPROM). The firmware program 37 may contain, for example, all the programming instructions required to control, for example, a keyboard 70, a display monitor 75, a mouse 80, a mobile data storage 65, other input/output devices not shown here, and a number of miscellaneous functions and/or devices. Memory 20 may also comprise a random access memory (RAM) 30. The OS and application programs may be loaded into RAM 30 for execution. RAM 30 may be volatile memory such that data in RAM 30 is typically lost when power is removed. IHS memory 20 may further comprise a computer readable medium (such as a portion of memory 20) that contains computer program instructions that when executed by CPU 16 performs for example but not limited to a method or function as described herein. The memory 20 may further contain a database and data structure having fields for containing data indicative of field values such as an IHS identifier, discussed below.

Fixed data storage device 25 may be used to store the OS, application programs, and other data for use by IHS 5. A fixed data storage device refers to non-volatile storage devices including permanent and/or semi-permanent storage devices. Fixed data storage devices may include but are not limited to, a hard disk drive (HDD) and a magnetic tape drive. In addition, a mobile data storage device 65 may interface with local interface and power bus 40 for transferring data to and/or from IHS 5. Examples of mobile data storage include, but are not limited to: an external portable hard drive; a solid state semiconductor storage device, such as flash memory; and an optical disc storage device, such as a compact disc (CD) and/or a DVD,

The IHS 5 may further comprise a video display adapter 45: a plurality of input interfaces 50, a modem/network interface card (NIC) 55: and a plurality of output interfaces 60. Output interface 60 may transmit data to printer 90 for printing. IHS 5 may be coupled to an external network 95 through NIC 55 thus allowing the IHS 5 to send and receive data via the external network 95 to and from a remote device. As shown, the external network 95 may be a local area network (LAN), a wide area network (WAN), including the internet, or any other similar network. As described in FIG. 1, IHS 5 may operate as a personal computer, a network storage device, a network server, or any other enabled information handling device. The personal computer may be a desktop computer, a laptop computer, or a notebook computer.

In other embodiments IHS, additional components may be present or taken out of the IHS components as shown in FIG. 1. However, an FOT is not limited to using TPMs. Subscriber identity module (SIM) cards, smart cards, or any suitable hardware or software based security or basis for an FOT may be used as well. The hardware or software basis for the ROT or any other basis of authority or basis of trust.

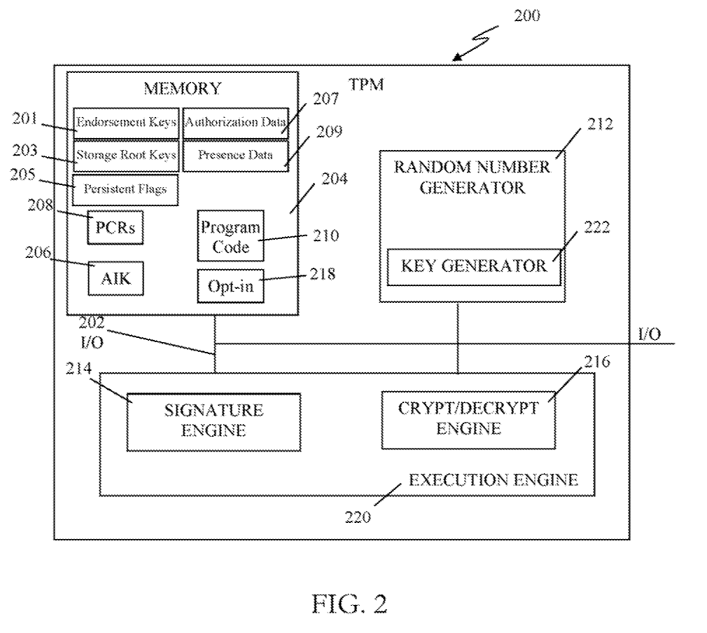

As described in the TCG specification a TPM contains certain components. In FIG. 2, an illustrative embodiment of a TPM 200 is illustrated. In an illustrative embodiment an input/output component 202 allows communications to and from the other components of the TPM 200. In a particular illustrative embodiment, the non-volatile TPM memory 204 is used to store endorsement keys 201, storage root keys 203, authorization data 207, persistent flags 206, platform configuration registers (PCRs) 208, presence data 209, or the like. Attestation identity keys 206 are used to perform attestation for the platform IHS. The program code 210 contains firmware for measuring trustworthiness of IHS devices. The random number generator 212 is used for key generation by key generator 222.

A signature engine 214 may be used for computing signatures. The encrypt/decrypt engine 216 is provided to be used for signing, encryption, decryption, or the like. In a particular illustrative embodiment the opt-in mechanism 218 is used to implement the Trusted Computing Group (TCG) policy that TPM modules are shipped in the state the customer desired. The execution engine 220 implements TPM initialization and measurement taking, and it may also run computer programs in the form of computer instructions stored in a computer readable medium such as an IHS memory. In a particular illustrative embodiment, a TPM may have additional components added to or components removed from TPM 200 components shown in FIG. 2.

A hardware TC may include but is not limited to one or more of a trusted platform module (TPM), a smart card, a SIM card, secure flash memory, or a similar hardware device. The hardware TC may be contained within an IHS. An ROT or FOT is created by initializing the TC. Access to the ROT may be tied to personal identification number (PIN) or similar identifying data. In some cases, ownership may be tied to the TC, FOT or ROT.

In a particular illustrative embodiment, a TPM is a hardware microcontroller that stores keys, passwords and/or digital certificates. A TPM may generally be attached to an IHS, where the ROT data or FOT data may be stored in the hardware TPM which is hardened or made more secure from external software attacks and physical theft. For example, access to data and secrets in an IHS having a TPM could be denied if the IHS boot sequence is not as expected by the TPM. Critical applications and capabilities such as secure email, secure web access and local protection of data are thereby made much more secure by a ROT such as a TPM, smart card. SIM card or similar hardware device or software program. The hardware basis for the ROT is more secure than a software basis for a ROT.

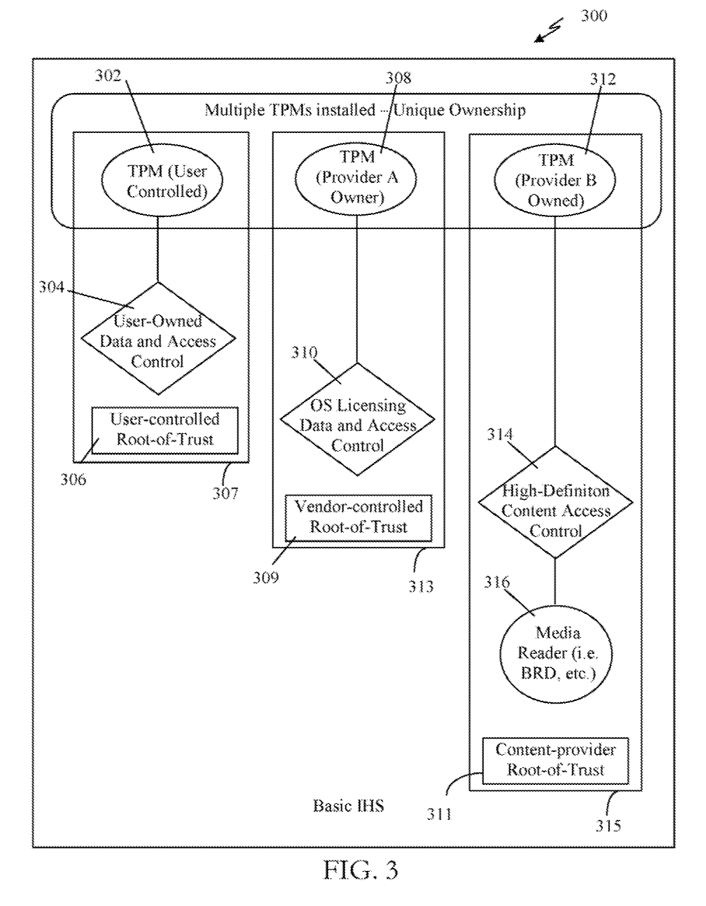

Turning now to FIG. 3, in a particular illustrative embodiment an information handling system (IHS) 300 is shown with three TPMs installed which each TPM having a unique and exclusive owner. TPM 302 is user owned and controlled which allows the user to access user-owned data and performs user access and control functions 304 associated with the user-owned TPM. The user-owned TPM 302 has created user-controlled ROT 306. The portion or domain of the trusted IHS controlled by the user-owned TPM is shown in FIG. 3 as IHS region or domain 307. A second TPM 308 is owned and controlled by a third party Provider A. Provider A might use the TPM 308 for license data, applications, runtime environment, and access control 310. Provider A owns and controls TPM 308 and the region 311 or domain controlled by TPM 308. Provider A uses TPM 308 to create a Provider A owned ROT 309. A third TPM 312 may be provided and be owned and controlled by Provider B. TPM 312 could be used for high-definition content access control 314 and/or media reader functions I.e. BRD, etc. at 316. Provider B owns and controls TPM 312 the region or domain controlled by TPM 312. Of course any number of TPMs may be provided as desired and not limited to two.

Features of hardware devices that form a basis for a ROT such as TPMs and associated or similar ROTs include but are not limited to remote attestation sealing, and binding. Remote attestation creates a summary of the software executing on an IHS that cannot easily be counterfeited or forged, which enables a third party to verify that the software on an IHS having a particular ROT has not been compromised. Sealing encrypts data in a manner that only allows the same IHS running the same software to encrypt the data to decrypt the data. Binding encrypts data using a TPM endorsement key or trusted key. Other features of TPM can be found in the TPM specification version 1.2, revision 94, published Mar. 29, 2006.

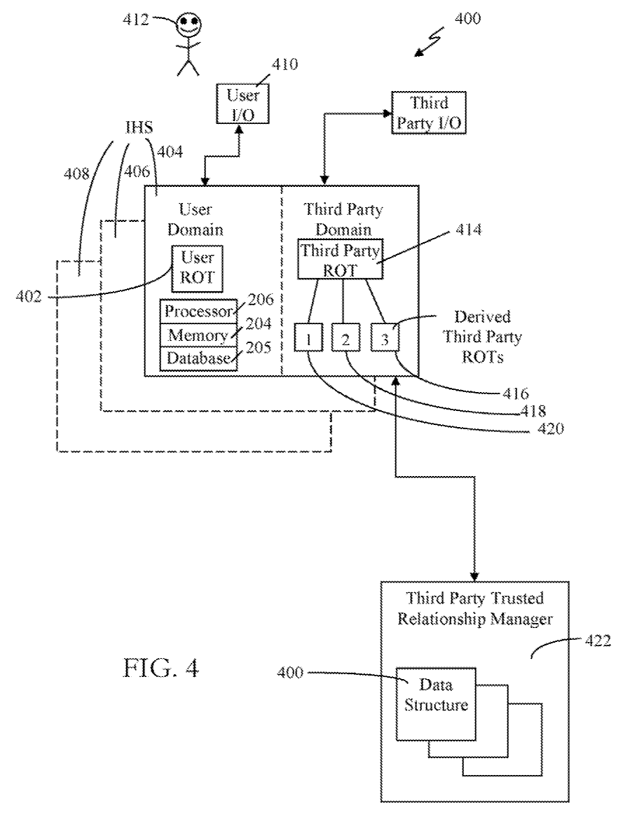

Turning now to FIG. 4 the TPM specification is hereby incorporated by reference in its entirety. Certainly, it is envisioned that this disclosure will have applicability with future versions of that specification. Additionally, user ROT 402 is owned by IHS user 412 allowing IHS user 412 to control user ROT 402 via user input/output display device 410. This user ownership possibly enables IHS user 412 to access, hack, modify, or otherwise compromise the user ROT 402. User 412 may also request action such as ROT reset from third party trusted relationship manager.

In a particular illustrative embodiment, an IHS contains multiple third party ROTs 414, 416 418 and 420 in addition to the user ROT. In an illustrative embodiment a primary third party ROT 414 is provided along with derivative third party ROTS 416, 418, and 420 which are derived from the primary ROT 414. The additional ROTs are third party ROTs that are not owned or controlled by the IHS user 412. In other words, in a particular illustrative embodiment the IHS user 412 has no control over the additional third party ROTs. Therefore, the additional third party ROTs are more secure and trustworthy than a ROT to which a user has access and/or control. In an illustrative embodiment, TPMs are used as the basis of trust to create ROTs. Alternatively, SIM cards, smart cards, or any suitable hardware or software based security mechanisms could be used for one of all of the user and third party bases of trust to create trusted relationships. However, in a particular illustrative embodiment for security and trust worthiness of TC modules, the TPM, SIM smart card or other hardware device or software program or component is uniquely and permanently bound and associated with a single and particular IHS.

In a particular illustrative embodiment the user ROT 402 is user owned and controlled. The user ROT 402 also contains or is associated with user owned data and/or access control data in memory 204. In an illustrative embodiment the user ROT is used for IHS authentication, integrity reporting protected storage, or any other processes that desire and/or require relationship in trusted computing. For example, the user ROT 402 can be used to attach a digital signature to a document, thereby allowing the recipient of the signed document to verify that the document is indeed from the user/person that digitally signed the document. In another particular illustrative embodiment, third party ROTs 414 are not used to digitally sign documents.

Other third party ROTs 414 are owned and controlled by third parties, that is, a trusted third party other than the IHS user. The third party ROT is controlled by a trusted third party other than the IHS user. The third party ROT may contain licensing data and/or access control data for use by a software vendor in memory 204. A third party ROT can be owned and controlled by a content provider. ROT data in memory 204 may contain content access control or endorsement keys. A third party such as an OEM can securely access and store information and data in an IHS having a third party basis of trust such as a ROT 414. For example, in an illustrative embodiment endorsement keys (EKs) or similar trust data is stored in the third party ROT that allows the playback of content stored on the IHS as shown in FIG. 2. Alternatively, a third party ROT 414 may be used for IHS authentication to ensure the identity of an IHS. For example, IHS authentication may be used for remote technical support from a third party, such as an original equipment manufacturer (OEM). A laptop computer OEM can verify that a laptop IHS is indeed a particular laptop using a third party ROT on the laptop IHS before providing remote technical support to the laptop IHS.

While digital rights management, content rights management, and remote technical support are some of the applications in which multiple ROTS may be used, the disclosure is not limited to such uses. The use of multiple ROTs facilitates software assurance, control, piracy prevention, confidentiality, as well as many other applications which require or desire a trusted relationship based on a ROT.

In a particular illustrative embodiment, the process of initializing a user ROT may require physical presence of the user. For example, a user may have to be physically present at an IHS to establish ownership of a user TC or ROT for the IHS. The IHS user may set presence in the software or hardware TC for the ROT. In an illustrative embodiment, setting presence means that the TC owner has set a personal identification number (PIN) that has established IHS ROT owner authentication. The TC owner may create an endorsement key (EK), and optionally add an endorsement key credential certified by a person or entity listed in the credential. The EK may also be set in a TC such as a TPM for an IHS by an OEM before shipping the IHS.

In another particular illustrative embodiment, an IHS is provided with a user TC (TPM) and third party TC (TPM). Initialization of the TPM is performed prior to creating an ROT. The user may set presence for the first user TC, but the user is not the owner of the third party TC. A third party, such as a vendor, OEM or content provider owns the third party TC, who typically does not want the user to be able to control or change the third party TC. The third party vendor, OEM or content provider need not be physically present to initialize the third party TC. In another particular illustrative embodiment, third party TCs, FOTs and ROTs can be owned and managed by a third party trusted relationship manager 422. TC, FOT and/or ROT data is stored in data structures 400 for each IHS and third party TC owner. The data structures 400 can be stored at the third party vendor/owner, IHS or at the third party trusted relationship manager.

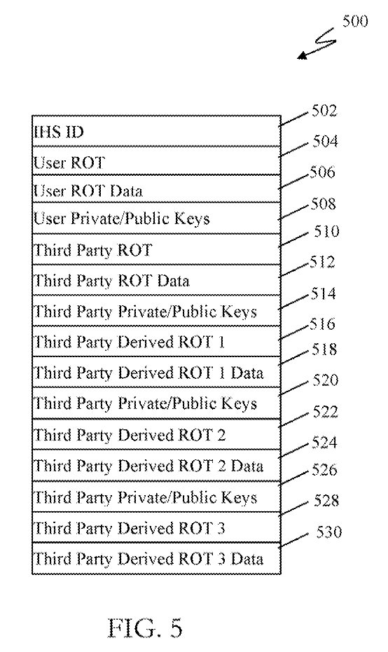

Turning now to FIG. 5, a data structure 500 is illustrated in which an information handling system (IHS) identification field 502 is provided for storing data indicative of an information handling system ID. The data structure 500 is stored in a computer readable medium such as the memory for the IHS. A user ROT field 504 is provided for containing data indicative of a user ROT or TRF. A user ROT data field 506 is also provided for storing data indicative of user ROT or TRF data such as EKs, public/private keys, etc. The user ROT or TRF data may comprise any of the data associated with a TRF or ROT discussed herein and may be used for the management and/or control of a particular user or third party ROT associated with a particular ROT.

The data structure further comprises third party ROT data which may contain third party ROT data used for controlling or managing a third party ROT or TRF associated with a particular IHS. A data structure exists for each IHS and may be stored at either a third party owner of a particular TRF or ROT or may be stored and controlled by a third party trusted relationship manager, which may manage ROTs and TRFs for multiple IHSs and third party owners of TRFs on the IHSs. The data structure 500 further comprises a third party ROT field 510 for storing third party ROT data indicative of a third party ROT. The data structure further comprises third party private and public keys which are stored in the third party private/public key data field 514.

The data structure further comprises a third party derived ROT 1 (TRF) field for containing data indicative of a third party derived ROT (TRF) at 516. The data structure further comprises a third party derived ROT data field for containing data indicative of third party derived ROT data used to manage or control the third party ROT 1 at 518. The data structure further comprises third party private/public keys field 520 for storing data indicative of third party private/public keys data associated with the third party private and third party ROT 1.

The data structure further comprises a third party derived ROT 2 field 522 for storing data indicative a third party derived ROT 2. The data structure further comprises a third party derived ROT 2 data field 524 for storing data indicative of a third party ROT 2 data. The data structure further comprises a third party private/public keys field 526 for storing data indicative of a third party private/public keys. Third party derived ROT 3 field 528 is provided in the data structure is used to store third party derived ROT 3 data indicative of a third party derived ROT. The data structure further comprises a third party derived ROT 3 data field 530 for containing ROT 3 data used for controlling or managing the third party derived ROT 3.

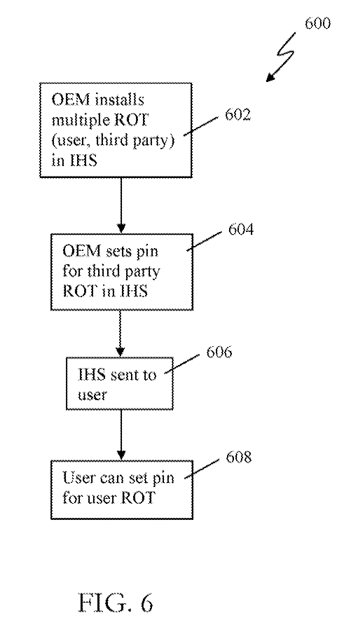

FIG. 6 illustrates a flow chart for a particular illustrative embodiment of a method 600 for initializing a user or third party ROT. The OEM installs multiple user or third party TCs in the IHS at block 602. The OEM also initializes the OEM TC by setting a PIN (generally a personal identification number, but as used herein, “PIN” may generically be any type of authentication key, code, number, combination, password, alphanumeric, mechanical key, magnetic key, biometric, or any sequence or combination of the foregoing) establishing owner authentication at block 604 and a TRF or ROT. The IHS as assembled and programmed by the OEM and sent to a user at block 606. The user may then take ownership of the user TC and set the user ROT at block 608. The OEM ROT remains under the ownership and control of the OEM. In a particular illustrative embodiment, the OEM ROT is not accessible by the IHS user.

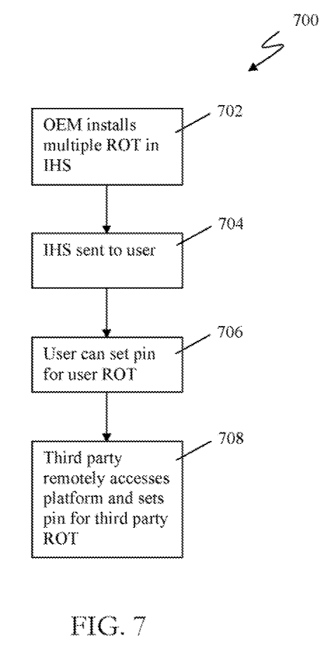

FIG. 7 is a flow chart for another illustrative embodiment of a method 700 in which an OEM performs remote initialization of user and third TCs/ROTs. In FIG. 7, the OEM installs multiple user and third party TCs in block 702 in the IHS and sends the IHS to the user at block 704. The user can set the user ROT or the user TC to establish ownership at block 706 of the user TC/ROT. The user ROT is then used to perform IHS attestation. A third party such as a vendor, OEM or content provider verifies that the user IHS is in fact who they represent themselves to be. The third party vendor, OEM or content provider them remotely accesses the IHS TC and sets the PIN for the third party TC and creates a third party ROT at block 708. The third party vendor, OEM or content provider may also provide TC/ROT data including but not limited to EKs for software assurance, control, and piracy prevention: on the IHS.

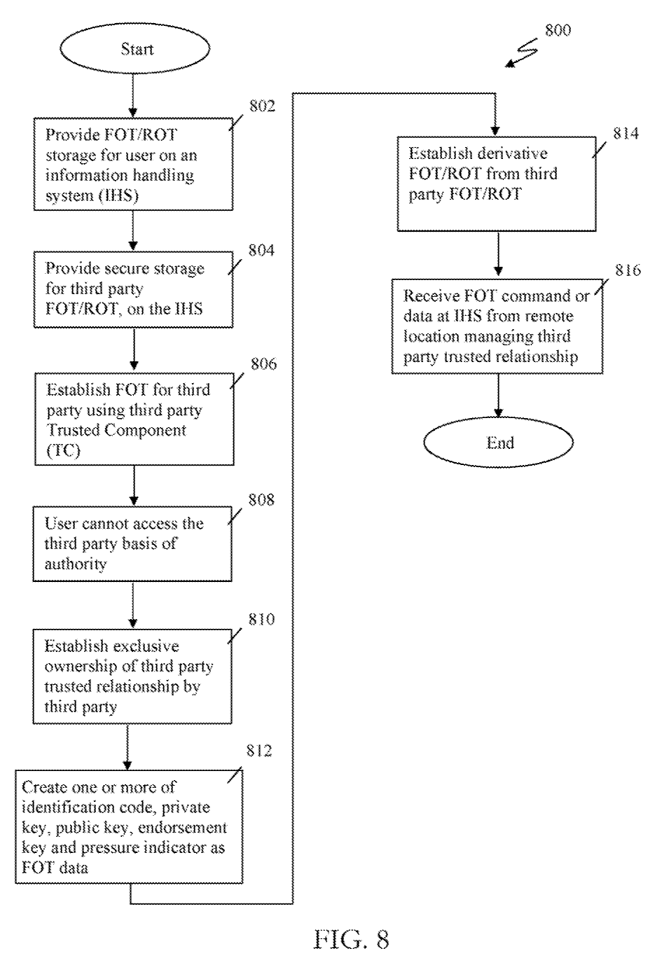

Turning now to FIG. 8, there is shown a flow chart depicting a particular illustrative embodiment of a method for establishing a trusted IHS. FOT/ROT storage is provided for user on an information handling system (IHS) at block 802. Secure storage for a third party TC is provided on the IHS at block 804. A TRF is established for a third party using a third party FOT at block 806. A user cannot access the third party TC at block 808. Exclusive ownership of third party TC is established by the third party at block 810. One or more of TC data such as identification code, private key, public key, endorsement key and pressure indicator is created as FOT/ROT data at block 812. A derivative ROT from a third party TC or ROT is established at block 814. FOT command or data is received at IHS from a remote location managing a third party trusted relationship at block 816.

In another particular illustrative embodiment there is a part of the IHS to which the user will not have access. Thus, an IHS user will have exclusive access to the majority of parts of the IHS and third party will have exclusive access to a very limited part of the same IHS. This concept is referred to as bifurcated access. A third party ROT is put in place that a third party somebody other than the user, owns/controls. The third party ROT drives or controls certain aspects of the IHS. For example, the path between a consumer of an MP3 and an audio device; or path between MP3 and video device; parts of that path selection will be beyond user control via the third party ROT. In a particular illustrative embodiment IHS bifurcated access is implemented with ROT, wherein the ROT indicates a controlling entity for particular domain in the bifurcated access IHS,

In a particular illustrative embodiment an entity that owns a particular primary ROT can reset the primary ROT and derivative ROTs based on the primary ROT and reset associated ROT data for the ROT and the derivative ROTs. In another particular illustrative embodiment an IHS user can wholly or partially reset all or a portion of a user or third party ROT (primary third party ROT and/or selected derivative third party ROTS) and associated ROT data either directly or by requesting a whole or partial reset from a third party that owns or manages ownership of a third party ROT. A user or third party can request that disinterested third party such as a trusted relationship manager 422 manages user and third party IHS ROTs and data. An IHS user or third party ROT can be established by any FOT device that provides a base of secure storage upon which a ROT or other form of trust can be formed. The secure storage may contain a key, password, secret material stored than only an owner of a third party ROT can access, reset or modify. The third party ROT ownership reduces risk of user hacking a third party ROT.

Third party ROTs provide secure storage to store keys to decrypt content third party ROTs can't be easily hacked or spoofed by a user or anyone other than the third party owner. Encrypted content can be stored anywhere an IHS. It's the key to encrypt such data that's protected by a ROT. For example, to download media, a media player IHS authenticates itself to a media server using a ROT, as “subscriber 13305”. The media player ROT can be used to securely download requested file to the disk if it's going to be written to the disk, onto an audio or video device.

In a particular illustrative embodiment, a ROT is used as control point which, from standpoint of a third party ROT owner, the third party ROT is a remote control point. In another particular illustrative embodiment the ROT can control audio playback, as media may be encrypted when downloaded to an IHS, or may be doubly encrypted (encrypt for transport and encrypted for content level). The content level encryption can be used to decrypt the content by a ROT in the audio player itself. When creating a ROT, a unique public and private key pair are created that will be used to sign and create other key pairs, of which one of those key pairs may be a digital certificate used for signing email. The public key and digital certificate is handed out to let others decode user documents, for example. The private key is stored or safetied through the ROT.

“EK”s represent the key that builds the core root of trust for the environment. An “EK” will be needed for each vested party that has a root of trust built into the PC. In another particular illustrative embodiment a TPM hardware TC initially has no owner. An EK is provided as a root key that enables establishment of a ROT for a particular TPM. The EK is created when an owner takes ownership of a TPM. An EK may not be there or not setup. Prior to establishing ownership of a TPM, there is no defined TPM ROT. Thus when taking ownership of a TPM, keys to establish the TPM are created. In a third party TPM or other basis of trust to create a ROT or trusted relationship, a third party can set presence remotely or presence can be set at an OEM. A third party ROT (primary ROT) and derivative ROTs for specific vendors can be generically provided set/reset per service desired.

The third party ROTs (primary and derivative) can be reset partially or wholly by a third party, all at once or one ROT at a time. In a particular illustrative embodiment a set ROT initialization process is performed when a TPM is initially provided, as no ROT has been established and no TPM owner has been previously established. TPM ownership indicates a PIN has been set that established owner authentication when ownership desired. Prior to establishing ownership, a prospective TPM owner sets a personal identification number (PIN) to establish the TPM. Once the TPM PIN is set an owner is established for the TPM. Trust encryption keys are then created by the TPM third party ROT that TPM can manage.

In a particular illustrative embodiment an EK is provided. The EK has been certified by an entity listed in credential for EK. In another particular illustrative embodiment, to set presence a TPM owner sets a bit on a TPM chip which signals the TPM that the TPM owner is present. In another particular illustrative embodiment, an IHS has public keys and/or derivative ROTs for every vendor. A trusted third party trusted relationship manager can take public keys ROTs and derivative ROTs created and archive them.

In another illustrative embodiment a third party ROT manager manages one or more ROTs for an IHS. An OEM can add new provider to a ROT using a derivative ROT. For remote terminal support an OEM can verify identify of an IHS using an OEM third party ROT. To enable secure remote management and technical support of an IHS of a PC (e.g. push down updates/remote in diagnose).

An illustrative embodiment provides a ROT as a noninvasive trust establishment path. There is no social step verification such as verbal interaction with a live operator and no opportunity for verbally misrepresenting OEM access numbers. An OEM can clear or reset ROTs on an IHS. Thus when an OEM replaces a mother board, the OEM can keep it and return it to stock, after clearing ROTs as the next customer to own the refurbished mother board may not want a preselect ROT vendors. Thus the OEM resets the ROTs to let next owner select new vendors ROTS. An OEM may also remotely reset the primary ROT or clear derivative ROTS or ROT data (primary or derivative).

In another particular embodiment a user can clear a derivative ROT or primary ROT wholly or as a partial ROT clear to reset a particular vendor associated with a particular ROT or a derivative ROT based on a third party ROT. In another particular embodiment a user can wholly or partially clear primary and derivative ROTs and data by requesting a whole or partial clear from a third party trusted relationship manager who manages the primary and derivative ROTs.

In non-limiting embodiments, part or all of the methods described herein may be described as instructions for an information handling system, and stored on one or more computer readable media or transmitted by a propagated signal.

In non-limiting embodiments, information handling systems are disclosed which are configured to carry out one or more of the methods described herein generally by having instructions for the methods stored thereon.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below,

What is claimed is:

1. A method for modifying an information handling system (IHS) comprising:
providing a user trusted component (TC) on the IHS; and
providing a third party TC on the IHS.

2. The method of claim 1, further comprising:
establishing a third party foundation of trust (FOT) on the IHS using the third party TC.

3. The method of claim 2, wherein the TC is a trusted platform module (TPM) and the FOT is a root of trust (ROT).

4. The method of claim 1, wherein the TC is selected from the group consisting of a subscriber identity module (SIM), software module secure flash and smart card.

5. The method of claim 1, further comprising establishing third party ownership of the third party TC.

6. The method of claim 5, wherein establishing third party ownership of the TC further comprises creating data comprising at least one selected from the group consisting of a personal identification number (PIN), a private key, a public keys an endorsement key and presence indicator.

7. The method of claim 2: further comprising:
establishing a derivative FOT from the third party FOT.

8. The method of claim 1, further comprising:
receiving data at the third party TC from outside the IHS a remote location managing the third party TC.

9. The method of claim 1, further comprising:
receiving data at the IHS resetting the third party TC wherein the data is sent from a source selected from the group consisting of an IHS user, a third party vendor, and a third party trusted relationship manager.

10. An information handling system (IHS) comprising:
a memory on the IHS;
a processor on the IHS in data communication with the memory;
a user trusted component (TC) on the IHS for establishing a user owned foundation of trust (FOT); and
a third party TC on the IHS for establishing a third party owned FOT.

11. The system of claim 10, wherein the third party TC is a trusted platform module (TPM) and the user owned FOT and third party owned FOT each are a root of trust (ROT).

12. The system of claim 10, wherein the user TC and the third party TC are each selected from the group consisting of a SIM, software module, secure flash, and smart card.

13. The system of claim 10, wherein the third party has exclusive access to the third party TC.

14. The system of claim 10, wherein the third party owned FOT is a root of trust (ROT) that receives data establishing third party ownership.

15. The system of claim 14, wherein the data establishing third party ownership further comprises data comprising at least one selected from the group consisting of a personal identification code, private key, public key, endorsement key and presence indicator.

16. A computer readable medium having a data structure stored thereon, the data structure comprising;
a first data field for storing data indicative of an IHS identifier; and
a second data field for storing data indicative of a third party FOT; and
a third data field for storing data indicative of a user FOT.

17. The data structure of claim 16, further comprising:
a fourth data field for storing data indicative of a derivative FOT.

18. A computer readable medium containing a computer program, the computer program comprising:
instructions to establish a user foundation of trust (FOT) on an information handling system (IHS) using a user trusted component (TC); and
instructions to establish a third party FOT on the IHS using a third party TC.

19. The computer readable medium of claim 18, the computer program further comprising:
instructions to establish third party ownership of the third party TC.

20. A method for operating on data an IHS having a user owned foundation of trust (FOT) and a third party owned FOT the method comprising:
sending data to the HIS wherein the data is controlled by the third party FOT; and
operating on the data using the third party owned FOT.
